(19) United States
(12) Patent Application Publication
(10) Pub. No.: US 2024/0278792 A1
(43) Pub. Date: Aug. 22, 2024

(54) TRAVEL CONTROLLER AND METHOD FOR TRAVEL CONTROL

(71) Applicant: TOYOTA JIDOSHA KABUSHIKI KAISHA, Toyota-shi (JP)

(72) Inventor: Wataru KAWASHIMA, Nisshin-shi (JP)

(73) Assignee: TOYOTA JIDOSHA KABUSHIKI KAISHA, Toyota-shi (JP)

(21) Appl. No.: 18/532,128

(22) Filed: Dec. 7, 2023

(30) Foreign Application Priority Data
Feb. 20, 2023 (JP) 2023-024080

(51) Int. Cl. B60W 50/00; G06T 11/00; G06V 10/82; G06V 20/58

(52) U.S. Cl. CPC B60W 50/0097; G06T 11/00; G06V 10/82; G06V 20/58; B60W 2420/403; B60W 2520/10

(57) ABSTRACT

A travel controller generates a future image by inputting a series of vicinity images representing surrounding conditions of a vehicle up to a current time into a first neural network. The future image represents predicted surrounding conditions of the vehicle at a future time that is a predetermined period after the current time. The travel controller generates a control signal for controlling travel of the vehicle by inputting a vicinity image outputted at the current time of the series of vicinity images, the future image, and the predetermined period into a second neural network different from the first neural network.

### FIELD

The present disclosure relates to a travel controller configured to generate a control signal for controlling travel of a vehicle and a method for travel control.

### BACKGROUND

A travel controller generates a control signal, based on a vicinity image representing surrounding conditions of a vehicle, and transmits the generated control signal to a travel mechanism of the vehicle, thereby executing autonomous driving of the vehicle.

A travel controller described in Japanese Patent No. 5341705 predicts a future position of an object in the vicinity of a host vehicle, based on positional information of the object detected at predetermined intervals, and provides assistance with collision avoidance, such as warning and automatic braking, when the host vehicle may collide with the object.

### SUMMARY

If a travel controller has controlled travel inappropriately according to a control signal generated depending on future surrounding conditions predicted based on vicinity images, it is not easy to determine whether the cause of such inappropriate control is prediction of the future surrounding conditions or generation of the control signal depending on the surrounding conditions and to take action appropriately.

It is an object of the present disclosure to provide a travel controller that can control travel of a vehicle appropriately, based on vicinity images.

The following is a summary of the present disclosure.

(1) A travel controller including a processor configured to:
generate a future image by inputting a series of vicinity images representing surrounding conditions of a vehicle up to a current time into a first neural network, the future image representing predicted surrounding conditions of the vehicle at a future time that is a predetermined period after the current time; and
generate a control signal for controlling travel of the vehicle by inputting a vicinity image outputted at the current time of the series of vicinity images, the future image, and the predetermined period into a second neural network different from the first neural network.

(2) The travel controller according to aspect (1), wherein in the case where the speed of the vehicle is less than a speed threshold, the processor generates the future image corresponding to a first future time that is a first predetermined period after the current time; and in the case where the speed of the vehicle is greater than the speed threshold, the processor generates the future image corresponding to a second future time that is a second predetermined period after the current time, the second predetermined period being shorter than the first predetermined period.

(3) The travel controller according to aspect (1) or (2), wherein the processor is further configured to cause the future image to appear on a display mounted on the vehicle.

(4) A method for travel control executed by a travel controller configured to generate a control signal for controlling travel of a vehicle, the method including:
generating a future image by inputting a series of vicinity images representing surrounding conditions of the vehicle up to a current time into a first neural network, the future image representing predicted surrounding conditions of the vehicle at a future time that is a predetermined period after the current time; and
generating the control signal by inputting a vicinity image outputted at the current time of the series of vicinity images, the future image, and the predetermined period into a second neural network different from the first neural network.

(5) A non-transitory computer-readable medium storing a computer program for travel control, the computer program causing a computer mounted on a vehicle to execute a process including:
generating a future image by inputting a series of vicinity images representing surrounding conditions of the vehicle up to a current time into a first neural network, the future image representing predicted surrounding conditions of the vehicle at a future time that is a predetermined period after the current time; and
generating a control signal for controlling travel of the vehicle by inputting a vicinity image outputted at the current time of the series of vicinity images, the future image, and the predetermined period into a second neural network different from the first neural network.

The travel controller according to the present disclosure can control travel of the vehicle appropriately, based on vicinity images.

### BRIEF DESCRIPTION OF DRAWINGS

FIG. 1 schematically illustrates the configuration of a vehicle equipped with a travel controller.

FIG. 2 schematically illustrates the hardware of the travel controller.

FIG. 3 is a functional block diagram of a processor included in the travel controller.

FIG. 4 schematically illustrates operation of the travel controller.

FIG. 5 is a flowchart of a travel control process.

### DESCRIPTION OF EMBODIMENTS

A travel controller that can control travel of a vehicle appropriately, based on vicinity images, will now be described in detail with reference to the attached drawings. The travel controller of the present disclosure generates a future image by inputting a series of vicinity images representing surrounding conditions of a vehicle up to a current time into a first neural network. The future image represents predicted surrounding conditions of the vehicle at a future time that is a predetermined period after the current time. The travel controller generates a control signal for controlling travel of the vehicle by inputting a vicinity image outputted at the current time of the series of vicinity images, the future image, and the predetermined period into a second neural network. The second neural network is a neural network different from the first neural network. Surrounding conditions include, for example, the positional relationship between the vehicle and objects around the vehicle.

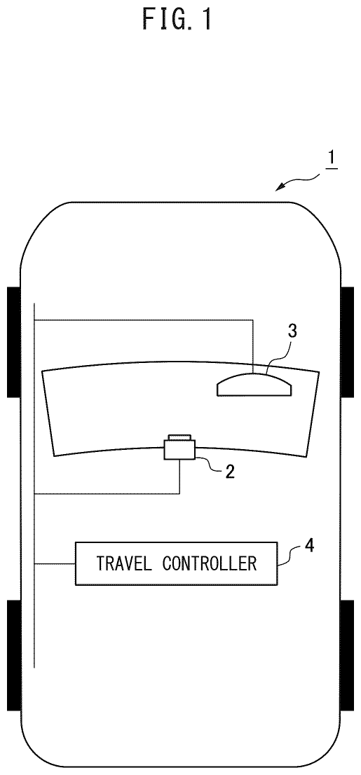

FIG. 1 schematically illustrates the configuration of a vehicle equipped with the travel controller.

The vehicle 1 includes a camera 2 for generating images representing surrounding conditions, a meter display 3, and a travel controller 4. The travel controller 4 is an example of the travel controller. The camera 2 and the meter display 3 are communicably connected to the travel controller 4 via an in-vehicle network conforming to a standard such as a controller area network.

The camera 2 is an example of an image capturing unit that outputs vicinity images representing surrounding conditions of the vehicle. The camera 2 includes a two-dimensional detector constructed from an array of optoelectronic transducers, such as CCD or C-MOS, having sensitivity to visible light and a focusing optical system that forms an image of a target region on the two-dimensional detector. The camera 2 is disposed, for example, in a front upper area in the vehicle interior and oriented forward, takes a picture of surrounding conditions of the vehicle 1 through a windshield every predetermined capturing period (e.g., 1/30 to 1/10 seconds), and outputs time-series vicinity images representing the surrounding conditions. The vicinity images are an example of output data of the image capturing unit. As the image capturing unit, the vehicle 1 may include a light detection and ranging (LiDAR) sensor that generates a range image, as vicinity data, whose pixels each have a value depending on the distance to an object represented in the pixel, based on surrounding conditions of the vehicle 1.

The meter display 3, which is an example of a display unit, includes, for example, a liquid crystal display. The meter display 3 displays a screen for notifying information to a driver, according to a signal received from the travel controller 4 via the in-vehicle network.

The travel controller 4 is an electronic control unit (ECU) including a communication interface, a memory, and a processor. The travel controller 4 generates a control signal for controlling travel of the vehicle 1, based on vicinity images received from the camera 2 via the communication interface, and outputs the control signal to a travel mechanism (not illustrated) of the vehicle 1. The travel mechanism includes, for example, an engine or a motor for powering the vehicle 1, brakes for decelerating the vehicle 1, and a steering mechanism for steering the vehicle 1.

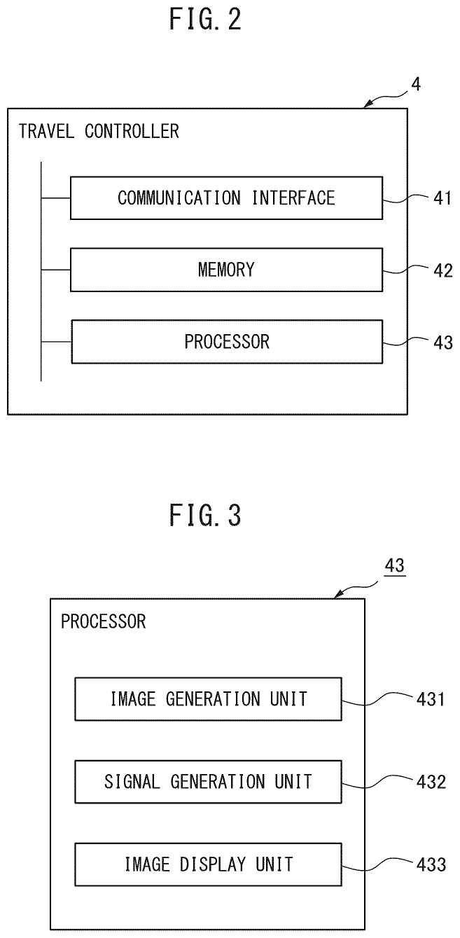

FIG. 2 schematically illustrates the hardware of the travel controller 4. The travel controller 4 includes a communication interface 41, a memory 42, and a processor 43.

The communication interface 41, which is an example of a communication unit, includes a communication interface circuit for connecting the travel controller 4 to the in-vehicle network. The communication interface 41 provides received data for the processor 43, and outputs data provided from the processor 43 to an external device.

The memory 42, which is an example of a storage unit, includes volatile and nonvolatile semiconductor memories. The memory 42 stores various types of data used for processing by the processor 43, e.g., sets of parameters for specifying first and second neural networks (e.g., the number of layers, layer configuration, kernels, and weighting factors). The memory 42 also stores various application programs, e.g., a program for travel control used for executing a travel control process.

The processor 43, which is an example of a control unit, includes one or more processors and a peripheral circuit thereof. The processor 43 may further include another operating circuit, such as a logic-arithmetic unit, an arithmetic unit, or a graphics processing unit.

FIG. 3 is a functional block diagram of the processor 43 included in the travel controller 4.

As its functional blocks, the processor 43 of the travel controller 4 includes an image generation unit 431, a signal generation unit 432, and an image display unit 433. These units included in the processor 43 are functional modules implemented by a program executed by the processor 43. The computer program for achieving the functions of the units of the processor 43 may be provided in a form recorded on a computer-readable portable storage medium, such as a semiconductor memory, a magnetic medium, or an optical medium. Alternatively, the units included in the processor 43 may be implemented in the travel controller 4 as separate integrated circuits, microprocessors, or firmware.

The image generation unit 431 generates a future image by inputting a series of vicinity images representing surrounding conditions of the vehicle 1 up to a current time into a first neural network The future image represents predicted surrounding conditions of the vehicle 1 at a future time that is a predetermined period after the current time.

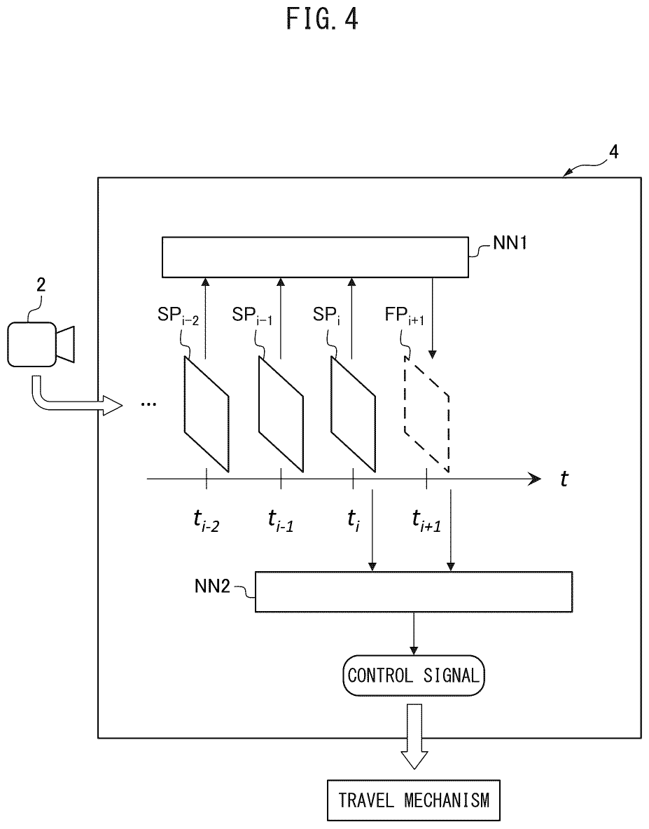

FIG. 4 schematically illustrates operation of the travel controller 4.

The camera 2 outputs time-series vicinity images representing surrounding conditions of the vehicle 1. Vicinity image SPᵢ₋₂ is outputted at time tᵢ₋₂, vicinity image SPᵢ₋₁ at time tᵢ₋₁ later than time tᵢ₋₂, and vicinity image SPᵢ at current time tᵢ later than time tᵢ₋₁.

The image generation unit 431 inputs the series of vicinity images SPᵢ₋₂, SPᵢ₋₁, and SPᵢ obtained from the camera 2 via the communication interface 41 into a first neural network NN1.

The first neural network NN1 is configured by a convolutional neural network (CNN) including convolution layers connected in series from the input side toward the output side, such as SDC-Net. The first neural network NN1 may be configured by a network that combines a CNN and a recurrent neural network (RNN), such as PredNet.

The first neural network NN1 is trained in advance using, as training data, a large number of series of images selected from moving image data representing surrounding conditions of a vehicle, which is obtained during travel of the vehicle, so as to generate an image of a new time from images of old times among each series of images. For training the first neural network NN1 may be used a predetermined training technique, such as backpropagation.

The image generation unit 431 obtains future image FPᵢ₊₁ from the first neural network NN1 into which the series of vicinity images is inputted, thereby generating a future image representing predicted surrounding conditions of the vehicle 1 at future time tᵢ₊₁ that is a predetermined period after current time tᵢ.

The predetermined period between current time tᵢ and future time tᵢ₊₁ corresponds to the interval at which the camera 2 outputs vicinity images, and is, for example, 1/10 seconds. As the future image, the image generation unit 431 may generate future image FPᵢ₊₂ corresponding to future time tᵢ₊₂ obtained by recursively inputting a series of vicinity images including future image FPᵢ₊₁, which is outputted from the first neural network NN1, as an image of the current time into the first neural network NN1. In this case, the predetermined period between current time tᵢ and future time tᵢ₊₂ corresponds to twice the interval at which the camera 2 outputs vicinity images. The image generation unit 431 can generate a future image corresponding to a future time that is a longer predetermined period after the current time by recursively inputting a series of images including a future image outputted from the first neural network NN1 into the first neural network NN1 in this way.

Referring back to FIG. 3, the signal generation unit 432 generates a control signal for controlling travel of the vehicle by inputting a vicinity image outputted at the current time of the time-series vicinity images, the future image, and the predetermined period into a second neural network.

In the example of FIG. 4, the signal generation unit 432 inputs vicinity image SPᵢ outputted at current time tᵢ, future image FPᵢ₊₁, and the predetermined period corresponding to the interval between current time tᵢ and future time tᵢ₊₁ into a second neural network NN2.

The second neural network NN2 includes, for example, a CNN that calculates a feature from an image, such as VGG16, and a fully-connected network including fully-connected layers in which nodes belonging to a layer are connected to all nodes in the preceding layer. The second neural network NN2 having such a configuration calculates features of a vicinity image and a future image in response to input of these images into channels included in the CNN. The fully-connected network outputs a control signal, based on input of the features of the vicinity image and the future image calculated by the CNN and the predetermined period.

The second neural network NN2 is trained in advance using, as training data, a large number of pairs of images selected from moving image data representing surrounding conditions of a vehicle, which is obtained during travel of the vehicle, the interval at which images forming each pair are outputted (predetermined period), and a control signal to be outputted to a travel mechanism at the later time of the times of output of images forming each pair, so as to generate a control signal to be outputted to the travel mechanism at the later time from a pair of inputted images. For training the second neural network NN2 may be used a predetermined training technique, such as backpropagation.

The signal generation unit 432 obtains a control signal from the second neural network NN2 into which vicinity image SPᵢ outputted at current time tᵢ, future image FPᵢ₊₁, and the predetermined period corresponding to the interval between current time tᵢ and future time tᵢ₊₁ are inputted, thereby generating a control signal for controlling the vehicle 1.

For example, assume that a vehicle traveling ahead of the vehicle 1 by a distance greater than a predetermined vehicle-to-vehicle distance threshold is represented in a vicinity image corresponding to the current time, and that the vehicle ahead is represented in a future image corresponding to a future time that is a predetermined period after the current time, but is traveling ahead of the vehicle 1 by a distance less than the vehicle-to-vehicle distance threshold. In this case, the signal generation unit 432 may generate, for example, a control signal for applying brakes to decelerate the vehicle 1, depending on output of the trained second neural network NN2.

Referring back to FIG. 3, the image display unit 433 causes the future image to appear on the meter display 3. In this way, the driver of the vehicle 1 can visually confirm the future image used for travel control by the travel controller 4, thereby determining whether travel control is appropriate.

As described above, the travel controller 4 of the present disclosure uses the first neural network NN1 and the second neural network NN2 for generating a control signal based on vicinity images. Such a configuration enables the neural networks to be trained in parallel to generate a future image and a control signal, respectively. If an appropriate control signal is not generated from vicinity images, the cause of the trouble can be searched for more appropriately by checking the generated future image.

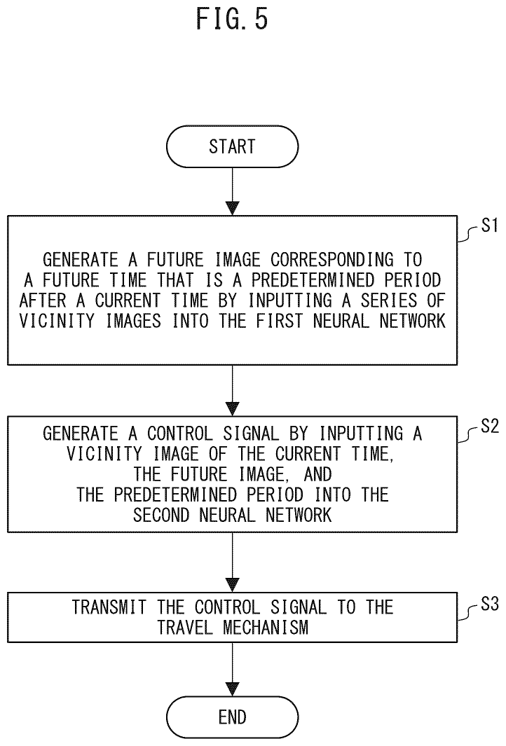

FIG. 5 is a flowchart of the travel control process. During execution of autonomous driving control, the travel controller 4 repeatedly executes the travel control process described below, every predetermined execution time (e.g., every 1/10 seconds).

The image generation unit 431 of the processor 43 of the travel controller 4 generates a future image, which represents predicted surrounding conditions of the vehicle 1 at a future time, by inputting a series of vicinity images up to a current time into the first neural network NN1 (step S1).

Next, the signal generation unit 432 of the processor 43 generates a control signal for controlling travel of the vehicle 1 by inputting a vicinity image outputted at the current time of the series of vicinity images, the future image, and the predetermined period into the second neural network NN2 (step S2).

Subsequently, the signal generation unit 432 transmits the generated control signal to the travel mechanism of the vehicle 1 (step S3), and terminates the travel control process.

By executing the travel control process in this way, the travel controller 4 can control travel of the vehicle appropriately, based on vicinity images.

According to a modified example, the image generation unit 431 may generate future images corresponding to different future times, whose predetermined periods from the current time differ from each other, depending on the speed of the vehicle 1. For example, in the case where the speed of the vehicle 1 is less than a speed threshold stored in the memory 42, the image generation unit 431 generates a future image of a future time that is a first predetermined period after the current time. In the case where the speed of the vehicle 1 is greater than the speed threshold, the image generation unit 431 generates a future image of a future time that is a second predetermined period after the current time; the second predetermined period is shorter than the first predetermined period.

As described above, the image generation unit 431 can generate a future image corresponding to a future time that is a longer predetermined period after the current time by recursively inputting a series of images including a future image outputted from the first neural network NN1 into the first neural network NN1. Thus, in the case where the speed of the vehicle 1 is greater than the speed threshold, the image generation unit 431 may generate, for example, future image FPᵢ₊₁ corresponding to future time tᵢ₊₁ outputted from the first neural network NN1, as the future image. Future time tᵢ₊₁ is an example of the second future time, and the interval between current time tᵢ and future time tᵢ₊₁ is an example of the second predetermined period. In the case where the speed of the vehicle 1 is less than the speed threshold, the image generation unit 431 may generate, for example, future image FPᵢ₊₂ corresponding to future time tᵢ₊₂ obtained by recursively inputting a series of vicinity images including future image FPᵢ₊₁, which is outputted from the first neural network NN1, as an image of the current time into the first neural network NN1, as the future image. Future time tᵢ₊₂ is an example of the first future time, and the interval between current time tᵢ and future time tᵢ₊₂ is an example of the first predetermined period.

By the image generation unit 431 generating future images in this way, the travel controller 4 can generate a control signal more appropriately, depending on the speed of the vehicle 1.

It should be noted that those skilled in the art can make various changes, substitutions, and modifications without departing from the spirit and scope of the present disclosure.

What is claimed is:

1. A travel controller comprising a processor configured to:
generate a future image by inputting a series of vicinity images representing surrounding conditions of a vehicle up to a current time into a first neural network, the future image representing predicted surrounding conditions of the vehicle at a future time that is a predetermined period after the current time; and
generate a control signal for controlling travel of the vehicle by inputting a vicinity image outputted at the current time of the series of vicinity images, the future image, and the predetermined period into a second neural network different from the first neural network.

2. The travel controller according to claim 1, wherein in the case where the speed of the vehicle is less than a speed threshold, the processor generates the future image corresponding to a first future time that is a first predetermined period after the current time; and in the case where the speed of the vehicle is greater than the speed threshold, the processor generates the future image corresponding to a second future time that is a second predetermined period after the current time, the second predetermined period being shorter than the first predetermined period.

3. The travel controller according to claim 1, wherein the processor is further configured to cause the future image to appear on a display mounted on the vehicle.

4. A method for travel control executed by a travel controller configured to generate a control signal for controlling travel of a vehicle, the method comprising:
generating a future image by inputting a series of vicinity images representing surrounding conditions of the vehicle up to a current time into a first neural network, the future image representing predicted surrounding conditions of the vehicle at a future time that is a predetermined period after the current time; and
generating the control signal by inputting a vicinity image outputted at the current time of the series of vicinity images, the future image, and the predetermined period into a second neural network different from the first neural network.

5. A non-transitory computer-readable medium storing a computer program for travel control, the computer program causing a computer mounted on a vehicle to execute a process comprising:
generating a future image by inputting a series of vicinity images representing surrounding conditions of the vehicle up to a current time into a first neural network, the future image representing predicted surrounding conditions of the vehicle at a future time that is a predetermined period after the current time; and
generating a control signal for controlling travel of the vehicle by inputting a vicinity image outputted at the current time of the series of vicinity images, the future image, and the predetermined period into a second neural network different from the first neural network.
